(19) United States
(12) Patent Application Publication
(10) Pub. No.: US 2011/0248976 A1
(43) Pub. Date: Oct. 13, 2011

(54) DISPLAY APPARATUS

(75) Inventors: Ryuichiro Isobe, Chiba-shi (JP); Noriyuki Kaifu, Mobara-shi (JP)

(73) Assignee: CANON KABUSHIKI KAISHA, Tokyo (JP)

(21) Appl. No.: 13/078,233

(22) Filed: Apr. 1, 2011

(30) Foreign Application Priority Data
Apr. 7, 2010 (JP) 2010-088801

(51) Int. Cl. G06F 3/038; G09G 3/20

(52) U.S. Cl. 345/208; 345/55

(57) ABSTRACT

A display apparatus which achieves high definition and has excellent resolution that the human eye feels is provided. In the display apparatus which comprises a display region on which a plurality of display devices are arranged in a matrix, the plurality of display devices include a first display device, a second display device and a third display device, and are arranged in order of the first display device, the second display device, the third display device, the third display device, the second display device and the first display device in a first direction, luminescent colors of the first display device, the second display device and the third display device are different from others, and the display apparatus comprises a low-pass filter circuit configured to modulate an image signal to be input to the display region.

### BACKGROUND OF THE INVENTION

1. Field of the Invention

The present invention relates to a display apparatus.

2. Description of the Related Art

In recent years, a self-luminous display apparatus using a self-luminous device such as an organic EL (electroluminescence) device or the like is used.

Among these display apparatuses respectively using the organic EL devices, each of the small-sized display apparatuses is mostly manufactured in such a manner that an organic EL layer is formed by mask vapor deposition to have a pattern of display devices of R (red), G (green) and B (blue). For this reason, a high-definition mask comes to be required as the display apparatus becomes high-definition. However, it is difficult to manufacture the high-definition mask like this with accuracy. Besides, when a film is formed by using the high-definition mask, misalignment of film formation position easily occurs due to misalignment between a plate on which the film is formed and the mask, a temperature change in the vapor deposition, and the like.

To avoid such problems occurring by such definition growth of the organic EL device, in Japanese Patent Application Laid-Open No. 2004-207126, display devices of respective colors are arranged in a sequence of RGBBGRRGBBGR . . . when viewed from, e.g., a row direction. In such an arrangement, the display devices are arranged so that, if it is assumed that the display devices of R, G and B constitute one pixel, the display devices of the same color included respectively in the adjacent pixels are adjacent to each other. In the case where the display devices of the respective colors are arranged in the above sequence (RGBBGRRGBBGR . . . ), when the R and B display devices are respectively formed by vapor deposition, a mask aperture can be set to have a width corresponding to the size of the two display devices. Thus, since the apertures of the mask can be formed with resolution half the actual resolution in case of forming the R and B display devices, the problem occurring by the definition growth of the display apparatus can be improved.

Further, as another method of making a high-definition display apparatus, there has been proposed a technique of setting a sequence of display devices of respective colors as RGBGRGBG . . . , arranging only the G display device with desired high definition, and making the width of each of the R and B display devices twice as large as the width of the G display device (Japanese Patent Application Laid-Open No. 2005-062220; or U.S. Pat. No. 7,283,142). In this case, each of the R and B display devices is shared by the two adjacent units of display.

Incidentally, since a human visual system has a high spatial resolution characteristic in regard to green light, to increase the number of the G display devices particularly contributes to improvement of the resolution of the display apparatus. On another front, in the display devices which have the above sequence (RGBGRGBG . . . ), it is necessary to convert image information according to the numbers of the R, G and B display devices. Namely, since such an image information conversion process is a process to reduce the numbers of R and B image signals according to the numbers of the respective display devices, it is desirable to use a low-pass filtering characteristic to avoid aliasing distortion caused by resampling, as described in Watanabe Eiji, Digital Signal Processing Systems, Morikita Publishing, (2008). On another front, Japanese Patent Application Laid-Open No. 2005-062220 discloses, as an image information conversion method, a process of inputting luminance information being an average of luminance information of adjacent R or B to each display device. Since the luminance information of R or B is averaged in a plane direction in this case, this process is practically equivalent to a case where a low-pass filter circuit is provided.

As described above, in the display apparatus in which the display devices are arranged in such a manner as disclosed in Japanese Patent Application Laid-Open No. 2005-062220 or U.S. Pat. No. 7,283,142, it is possible to efficiently improve sensate resolution of the display apparatus in contrast to the total number of the display devices by increasing the number of only the G display devices. Here, in the present application, the sensate resolution represents the resolution that the human eye feels. However, in this case, since the number of the G display devices is different from the number of the R display devices and the number of the B display devices, there is a possibility that unnecessary color appears when a fine patterns is displayed. Besides, there is a possibility that, since the sensate resolution becomes different according to appeared color, a user has a feeling of strangeness when he/she observes the displayed pattern.

On the other hand, in the sequence of the display devices constituting the display apparatus disclosed in Japanese Patent Application Laid-Open No. 2004-207126, the display devices of the respective colors are divided for each unit of display, and each unit can independently emit light. For this reason, the problem due to the above-described constitution that the number of the display devices is different for each color is hard to occur, whereby it is possible to easily achieve high-resolution image display. However, in the sequence of the display devices disclosed in Japanese Patent Application Laid-Open No. 2004-207126, although arrangement pitches of the G display devices are equal, arrangement pitches of the R or B display devices are not equal, i.e., ⅓ times or 2 times.

Here, in a case where the sequence of the display devices is RGBRGBRGBRGB . . . , a feeling of blur among the display devices according to an observation distance to the display apparatus is equal for all of R, B and G. It has been known that a limit that a person having eyesight of “1.0” can distinguish a gap of a Landolt ring generally used in an eyesight test is about one minute in angle. Such an angle is equivalent to a viewing angle of a pixel pitch of each color in case of observing an RGB panel of three-inch VGA (Video Graphics Array) of a general display device arrangement at a distance of 25 cm or so. In other words, it is difficult for the user to discriminate the adjacent display devices when he/she observers the display apparatus at a distance of about 25 cm or more.

On the other hand, in the case where the sequence of the display devices is RGBBGRRGBBGR . . . , at the point where the pitch of the R display devices is ⅓ of the pitch of the G display devices, the adjacent R display devices cannot be discriminated at an observation distance which is ⅓ of an observation distance at which the G display devices can be discriminated. Therefore, in case of observing the display apparatus at a distance (hereinafter, called “R non-discriminable distance”) which is larger than an observation distance at which the R display devices can be discriminated, when the sequence of the display devices is RGBBGRRGBBGR . . . , the relevant sequence is observed as being substantially equivalent to the sequence of the display devices of RGBGRGBG . . . .

Here, as described above, in the case where the sequence of the display devices is RGBGRGBG . . . , it is necessary to provide the low-pass filter circuit for the resolution conversion according to the differences of the numbers of the display devices of the respective colors. However, in the case where the sequence of the display devices is RGBBGRRGBBGR . . . , the substantial sequence of the display devices changes according to the observation distance. Thus, when the low-pass filter circuit which is the same as that used in the case of the sequence of RGBGRGBG . . . , there is a possibility that image quality deteriorates according to the observation distance. For this reason, it is necessary to provide a low-pass filter circuit by which natural sensate resolution according to each observation distance can be obtained even if the observation distance changes.

The present invention has been completed to solve the above-described problems, and an object thereof is to provide a display apparatus which achieves high definition and has excellent sensate resolution.

### SUMMARY OF THE INVENTION

A display apparatus according to the present invention is characterized by a display apparatus which comprises a display region on which a plurality of display devices are arranged in a matrix, wherein the plurality of display devices include a first display device, a second display device and a third display device, and are arranged in order of the first display device, the second display device, the third display device, the third display device, the second display device and the first display device in a first direction, luminescent colors of the first display device, the second display device and the third display device are different from others, and the display apparatus comprises a low-pass filter circuit configured to modulate an image signal to be input to the display region.

Further features of the present invention will become apparent from the following description of exemplary embodiments with reference to the attached drawings.

### BRIEF DESCRIPTION OF THE DRAWINGS

FIG. 1 is a plan schematic diagram indicating an example that a display apparatus according to the present invention is actually carried out.

FIG. 2 is a schematic diagram for describing a signal process by a low-pass filter circuit in a case where a sequence of display devices is RGBGRGBG . . . .

FIG. 3 is a schematic diagram for describing a signal process by the low-pass filter circuit in a case where the sequence of the display devices is RGBBGRRGBBGR . . . .

FIG. 4 is a circuit diagram indicating an example of a signal processing circuit which is included in the low-pass filter circuit illustrated in FIG. 3.

### DESCRIPTION OF THE EMBODIMENTS

A display apparatus according to the present invention is a display apparatus which comprises a display region on which a plurality of display devices are arranged in a matrix, wherein the plurality of display devices include a first display device, a second display device and a third display device, and these display devices are arranged in a first direction (column direction) in order of the first display device, the second display device, the third display device, the third display device, the second display device, the first display device . . . .

Further, in the display apparatus according to the present invention, luminescent colors of the first display device, the second display device and the third display device are different from others, and the display apparatus comprises a low-pass filter circuit for modulating an image signal to be input to the display region.

Further, in the display apparatus according to the present invention, it is desirable that the first display device, the second display device and the third display device constitute one unit of display (pixel), the low-pass filter circuit is electrically connected to each unit of display, and an operation of the low-pass filter circuit for the display device on an even number column in the first direction is different from an operation of the low-pass filter circuit for the display device on an odd number column in the first direction.

Furthermore, in the display apparatus according to the present invention, it is desirable that a difference filter circuit for modulating the image signal output from the low-pass filter circuit is provided.

Hereinafter, the display apparatus according to the present invention will be described with reference to the attached drawings.

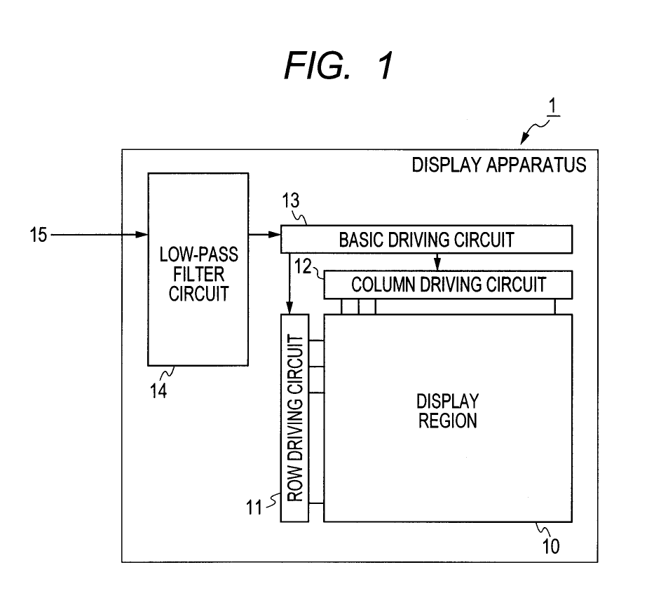

FIG. 1 is a plan schematic diagram indicating an example of the display apparatus according to the present invention. In FIG. 1, a display apparatus 1 has a plate (not illustrated) on which a display region 10, a column driving circuit 12, a row driving circuit 11, a basic driving circuit 13 and a low-pass filter circuit 14 are provided. Further, in the display apparatus 1 illustrated in FIG. 1, the display region 10 is electrically connected to the column driving circuit 12 and the row driving circuit 11, the column driving circuit 12 and the row driving circuit 11 are electrically connected to the basic driving circuit 13, and the basic driving circuit 13 is electrically connected to the low-pass filter circuit 14.

In the display apparatus 1 illustrated in FIG. 1, an externally transmitted image signal 15 is first input to the low-pass filter circuit 14. Here, a DVI (Digital Visual Interface) signal or an HDMI (High-Definition Multimedia Interface) signal which is used in a PC (personal computer) or an AV (audio visual) equipment, an NTSC (National Television System Committee) signal or a PAL (Phase Alternation by Line) signal which is used in television broadcasting, an LVDS (Low Voltage Differential Signaling) signal which is used in a note PC or the like, or the like can be used as one format of the image signal 15. Further, in addition to an RGB signal format, another signal format such as a YUV signal format or the like can be used as an encoding format of the image signal 15. Here, when the YUV signal format is used, a conversion circuit (not illustrated) for converting the YUV signal format into the RGB signal format before the image signal 15 is transferred to the basic driving circuit 13 is provided on the side before the low-pass filter circuit 14 (i.e., the side of a signal transmission source) or between the low-pass filter circuit 14 and the basic driving circuit 13.

The low-pass filter circuit 14 is the circuit which performs a specific signal process to the input image signal 15. Incidentally, the relevant specific signal process will be described later.

The image signal subjected to the specific signal process by the low-pass filter circuit 14 is then input to the basic driving circuit 13. The image signal input to the basic driving circuit 13 is synchronized with a row sync signal (not illustrated) or a column sync signal (not illustrated).

Here, the row sync signal is input to the display region 10 through the row driving circuit 11, while the column sync signal is input to the display region 10 through the column driving circuit 12. The row driving circuit 11 selects a display row in the display region 10 in response to the row sync signal, and then the column driving circuit 12 selectively inputs the image signal to the column corresponding to the selected display row.

In the display apparatus 1 illustrated in FIG. 1, the display devices of respective colors are arranged in the display region 10 so that a sequence of the display devices is RGBBGRRGBBGR . . . . Thus, the display devices of the respective colors emit light in response to the image signals input by the column driving circuit 12, whereby an image is displayed. Incidentally, although the basic driving circuit 13, the column driving circuit 12 and the row driving circuit 11 are respectively illustrated as different circuits in the display apparatus 1 of FIG. 1, these circuits need not necessarily be independently provided in the actual display apparatus 1. For example, the basic driving circuit 13, the column driving circuit 12 and the row driving circuit 11 may be formed on a low-temperature polysilicon TFT (thin-film transistor) base plate by the process same as that of manufacturing the display region 10.

Subsequently, an operation of the low-pass filter circuit 14 will be described. As described above, in the case where the sequence of the display devices is RGBBGRRGBBGR . . . , the relevant sequence is outwardly equivalent to the sequence of the display devices of RGBGRGBG . . . at the R non-discriminable distance or more.

Here, the low-pass filter circuit which is suitable for the case where the sequence of the display devices is RGBGRGBG . . . will be described.

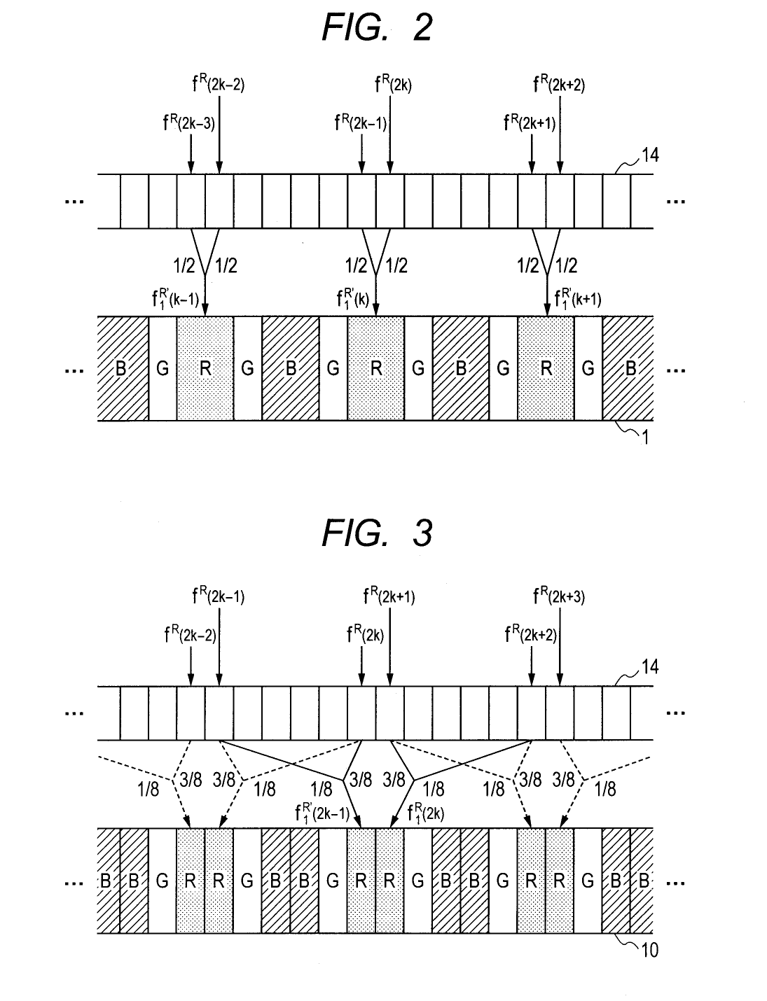

FIG. 2 is a schematic diagram for describing the signal process by the low-pass filter circuit in the case where the sequence of the display devices is RGBGRGBG . . . . FIG. 3 is a schematic diagram for describing the signal process by the low-pass filter circuit in the case where the sequence of the display devices is RGBBGRRGBBGR . . . .

In the low-pass filter circuit which is suitable for the case where the sequence of the display devices is RGBGRGBG . . . , a luminance information signal corresponding to the number of the G display devices is externally input. At this time, in R signals or B signals included in the original signals, a signal corresponding to a k-th column (for example, the k-th column when the leftmost column in the display region is assumed as a first column) of the original signal is set to f^{R}(k). Further, a signal corresponding to the k-th column of the signal obtained after the original signal passed the low-pass filter circuit is set to f₁^{R′}(k). At this time, a correspondence relation the R signal at the k-th column between before and after the signal process by the low-pass filter circuit is given as illustrated in, for example, FIG. 2. As illustrated in FIG. 2, the number of the R signals in the original signals is equivalent to the number of the G display devices. On the other hand, the number of the R signals after the conversion by the low-pass filter circuit 14 is equivalent to the number of the R display devices. Consequently, the number of the signals after the conversion by the low-pass filter circuit 14 is half the number of the original signals externally input. Therefore, the original signal corresponding to the location of f₁^{R′}(k) is f^{R}(2k). However, if f₁^{R′}(k) is simply defined as f₁^{R′}(k)=f^{R}(2k), image quality deteriorates due to the aliasing distortion described in Watanabe Eiji, Digital Signal Processing Systems, Morikita Publishing, (2008). To avoid such inconvenience, an FIR (finite impulse response) filter constitution is generally included in the low-pass filter circuit 14. When the FIR filter constitution is included in the low-pass filter circuit, a general expression which indicates the relation between the original signal and the signal after the conversion is given by the following expression (1).

$${f}_{1}^{{R}^{′}} ( k ) = {\sum }_{i = - ∞}^{∞} {a}_{i} {f}^{R} ( i ) \qquad ( 1 )$$

(aᵢ is a constant equal to or higher than −1 and equal to or lower than 1)

In the case where the sequence of the display devices is RGBBGRRGBBGR . . . , for example, a process of averaging the R signals respectively input to the adjacent R display devices (i.e., the R display device at the 2k-th column and the R display device at the (2k+1)th column) corresponds to a case where aᵢ in the expression (1) is given by a_{-∞}= . . . =a₂ₖ₋₁=0, a₂ₖ=a₂ₖ₊₁=½, and a₂ₖ₊₂= . . . =a_{∞}=0.

At this time, the R display device corresponding to the leftmost column corresponds to (2k+1)th column of k=0, and f₁^{R}(1) is equivalent thereto.

So, the following expression (1-1) is obtained from the expression (1). This process is a low-pass filtering process in the case where the FIR filter constitution is used.

$${f}_{1}^{{R}^{′}} ( k ) = \frac{1}{2} {f}^{R} ( 2 k ) + \frac{1}{2} {f}^{R} ( 2 k + 1 ) \qquad ( 1 \text{-} 1 )$$

To make a low-ass filtering characteristic in the vicinity of a cutoff frequency sharp, it is desirable that aᵢ is included in a numerical sequence obtained by performing inverse Fourier transform to a rectangular wave or a numerical sequence obtained by cutting off the value subjected to the inverse Fourier transform by a finite term. In this case, aᵢ is partially aᵢ<0.

As an example, in the expression (1), aᵢ is set as a_{-∞}= . . . =a₂ₖ₋₂=0, a₂ₖ₋₁=⅛, a₂ₖ=a₂ₖ₊₁=⅜, a₂ₖ₊₂=⅛, and a₂ₖ₊₃= . . . =a_{∞}=0.

So, the following expression (1-2) is obtained from the expression (1).

$${f}_{1}^{{R}^{′}} ( k ) = \frac{1}{8} {f}^{R} ( 2 k - 1 ) + \frac{3}{8} {f}^{R} ( 2 k ) + \frac{3}{8} {f}^{R} ( 2 k + 1 ) + \frac{1}{8} {f}^{R} ( 2 k + 2 ) \qquad ( 1 \text{-} 2 )$$

Incidentally, the above description is directed to the R display device. Also, it is possible for the B display device to define the relation between the original signal and the signal after the conversion by the following expression (2).

$${f}_{1}^{{B}^{′}} ( k ) = {\sum }_{i = - ∞}^{∞} {a}_{i} {f}^{B} ( i ) \qquad ( 2 )$$

(in the expression (2), f^{B} (i) indicates the i-th original signal, and f₁^{B′}(k) indicates the i-th signal after the conversion)

Hereinafter, the operation of the low-pass filter circuit which is included in the display apparatus of the present invention will be described in light of the above matters. In the display apparatus 1 illustrated in FIG. 1, the sequence of the display devices included in the display region 10 is RGBBGRRGBBGR . . . in the row direction. Further, the concrete image signal processing method in the low-pass filter circuit 14 of the display apparatus 1 is based on the expression (1) for the R display devices and based on the expression (2) for the B display devices.

The R display device in the above sequence can be independently driven. Here, a signal which is input to the R display device at the k-th column (k≦1) in the case where the sequence of the display devices is RGBGRGBG . . . is set to f₁^{R′}(k). In this case, “at the k-th column in the case where the sequence of the display devices is RGBGRGBG . . . ” corresponds to the R display device at the (2k−1)th column and the R display device at the 2k-th column in the case where the sequence of the display devices is RGBBGRRGBBGR . . . . The signals to be input to the relevant two R display devices are respectively set to fl₁^{R′}(2k−1) and fr₁^{R′}(2k). Here, if the R display device at the leftmost column is considered as the 0-th column and the left one of the adjacent two R display devices respectively provided immediately close to the R display device at the 0-th column is considered as the first column, the signal fr₁^{R′}(2k) is the signal to be input to the right one of the adjacent two R display devices, and the signal fl₁^{R′}(2k−1) is the signal to be input to the left one of the adjacent two R display devices.

Here, the relation of the signals f₁^{R′}(k), fr₁^{R′}(2k) and fl₁^{R′}(2k−1) is defined by the following expression (3).

f₁^{R′}(k)=fr₁^{R′}(2k)+fl₁^{R′}(2k−1) (3)

So, the effect equivalent to that in the case where the sequence of the display devices is RGBGRGBG . . . can be obtained at the R non-discriminable distance.

Further, the signals fr₁^{R′}(2k) and fl₁^{R′}(2k−1) in the expression (3) are defined by the following expression (4).

$${fl}_{1}^{{R}^{′}} ( 2 k - 1 ) = {\sum }_{i = - ∞}^{2 k - 1} {a}_{i} {f}^{R} ( i ) \\ {fr}_{1}^{{R}^{′}} ( 2 k ) = {\sum }_{i = 2 k}^{∞} {a}_{i} {f}^{R} ( i ) \qquad ( 4 )$$

By setting the signals fr₁^{R′}(2k) and fl₁^{R′}(2k−1) based on the above expressions (3) and (4), it is possible at an observation distance equal to or larger than the R non-discriminable distance to achieve the image quality equal to the image quality in the case where the sequence of the display devices is RGBGRGBG . . . . Further, it is possible to clearly observe the adjacent R display devices at the R non-discriminable distance. That is, it is possible to reduce deterioration of sensate resolution caused by the low-pass filter circuit. Therefore, it is possible to have the advantageous of the total number of the R display devices larger than that in the case where the sequence of the display devices is RGBGRGBG . . . (namely, the total number is twice as much as that in the case where the sequence of the display devices is RGBGRGBG . . . ), whereby the display apparatus which has high sensate resolution can be achieved. Incidentally, in the expression (4), aᵢ may be set in the same manner as that in case of the expression (1).

For example, a case of sending an R luminous signal in the method indicated in FIG. 3 is considered. This method is the same as the case of setting aᵢ as a_{-∞}=a₂ₖ₋₂=0, a₂ₖ₋₁=⅛, a₂ₖ=a₂ₖ₊₁=⅜, a₂ₖ₊₂=⅛, and a₂ₖ₊₃= . . . =a_{∞}=0 in the expression (4).

So, the following expression (4-1) is obtained from the expression (4).

$${fl}_{1}^{{R}^{′}} ( 2 k - 1 ) = \frac{1}{8} {f}^{R} ( 2 k - 2 ) + \frac{3}{8} {f}^{R} ( 2 k - 1 ) \\ {fr}_{1}^{{R}^{′}} ( 2 k ) = \frac{3}{8} {f}^{R} ( 2 k ) + \frac{1}{8} {f}^{R} ( 2 k + 1 ) \qquad ( 4 \text{-} 1 )$$

By setting the signals fr₁^{R′}(2k) and fl₁^{R′}(2k−1) as indicated by the expression (4-1), it is possible at an observation distance equal to or larger than the R non-discriminable distance to obtain the image quality equal to the image quality of the low-pass filter circuit used in the case where the sequence of the display devices is RGBGRGBG . . . .

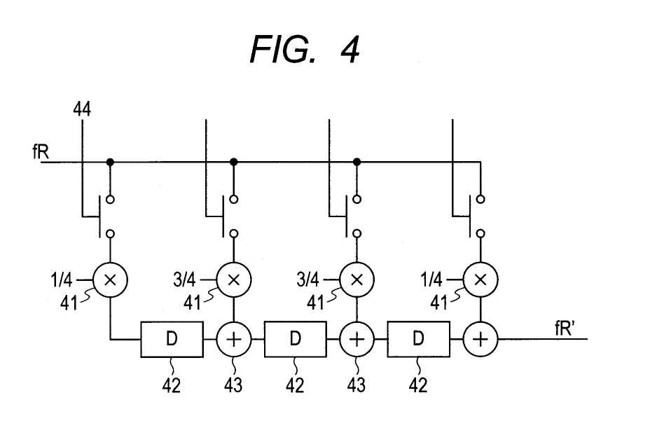

Subsequently, an example to which the expression (4-1) is implemented will be described with reference to the drawings. FIG. 4 is a circuit diagram indicating an example of a signal processing circuit which is included in the low-pass filter circuit illustrated in FIG. 3. Hereinafter, an example of conversion of image signals to be input to the R display devices will be concretely described. Incidentally, in the example illustrated in FIG. 4, each of externally transmitted image signals (f^{R}(2k+2), f^{R}(2k+1), f^{R}(2k), f^{R}(2k−1)) is converted into the signal fr₁^{R′}(2k) or fl₁^{R′}(2k−1) on the basis of the expression (4-1). FIG. 3 is illustrated as if the image signals corresponding to the respective columns are input at the same hour, for the purposes of explanation. However, in the actual embodiment, the image signals are input in chronological order, as described later.

The signal process illustrated in FIG. 4 will be described hereinafter. Incidentally, the following description corresponds to the concrete example that, in the display apparatus illustrated in FIG. 3, the image signals are input respectively to the (2k−1)th and 2k-th R display devices from the leftmost R display device. Further, the image signals are input in chronological order of f^{R}(1), f^{R}(2), . . . , f^{R}(2k−1), f^{R}(2k), f^{R}(2k+1), f^{R}(2k+2), . . . , f^{R}(2n−2), f^{R}(2n−1), and f^{R}(2n).

Here, to obtain the signal fr₁^{R′}(2k), the signals f^{R}(2k+2) and f^{R}(2k+1) are respectively transferred to a multiplication unit (multiplier 41), and these signals are multiplied together by the multiplication unit. For example, as illustrated in FIG. 4, a signal f^{R} is input to the multipliers respectively performing ¼, ¾, ¾ and ¼ multiplication processes at the same timing. Then, the outputs from the respective multipliers are input to delay elements 42. The delay element 42 outputs the signal input at one previous clock to a next stage in synchronization with the timing at which the input image signal f^{R} is input. Then, the obtained signals are added together by adders 43. Thus, the signal of the different column, i.e., the signal obtained by multiplying the coefficient aᵢ to the signal at a different clock time on a time series in the signal f^{R}, is added to a signal f^{R′} at the same timing, and the obtained signal is then output. Incidentally, the coefficient aᵢ is different according to the display column. On the other hand, by selecting whether or not to save the signal in the delay element 42 in response to a coefficient selection signal 44 of each column, it is possible to divisionally calculate the two formulas in the expression (4-1) according to the even number column and the odd number column.

Incidentally, since the circuit illustrated in FIG. 4 is one of concrete examples of the circuit to be provided in the low-pass filter circuit, the present invention is not limited to this. For example, when a display panel which is provided in the display apparatus has a dedicated input for each of the even number columns and the odd number columns in regard to R and B pixels, it is possible to omit the coefficient selection signals 44 illustrated in FIG. 4 by preparing the circuit illustrated in FIG. 4 to the inputs respectively. However, the display apparatus of the present invention has, in the low-pass filter circuit, at least the circuit which performs the multiplication process of multiplying the specific signal by the coefficient aᵢ, the delay element which adjusts the timing of the signal, and the adding unit which adds the plurality of signals together. Thus, by adequately adjusting the coefficient aᵢ based on the above-described expressions (3) and (4), it is possible to obtain an optimum signal to be input to the display device.

Incidentally, in the display apparatus of the present invention, the low-pass filter circuit may have a filtering characteristic for emphasizing a difference between the signals fr₁^{R′}(2k) and fl₁^{R′}(2k−1). Namely, by providing the relevant filtering characteristic, it is possible to obtain the constitution of further emphasizing sensate resolution (edge enhancement effect) in a case where observation is performed at a distance capable of separately discriminating the R display device at the (2k−1)th column and the R display device at the 2k-th column. The relevant filtering characteristic is to perform, for example, the process indicated by the following expression (5).

f₂^{R′}(2k)=f₁^{R′}(2k)+g(f₁^{R′}(2k)−f₁^{R′}(2k−1))

f₂^{R′}(2k−1)=f₁^{R′}(2k−1)+g(f₁^{R′}(2k−1)−f₁^{R′}(2k)) (5)

In the expression (5), the signals fr₂^{R′}(2k) and fl₂^{R′}(2k−1) respectively correspond to the signal input to the 2k-th (k≦1) and (2k−1)th R display devices after the difference filter circuit was applied. Further, symbol g indicates one kind of processing function for adjusting efficacy of the difference filter circuit.

At this time, in case of actually installing the low-pass filter circuit having the difference filter circuit, it is desirable to install the low-pass filter circuit which performs a calculation of substituting the expression (4-1) for the expression (5), thereby simplifying the calculation.

Although the signal to be input to the R display device is exemplified as described above, the present invention is not limited to this. For example, it is possible to perform the same signal process also to the B display devices which has the same arrangement as that of the R display devices.

In the present embodiment, the display devices are arranged in the order of RGB in the unit of display of the even number column, while the display devices are arranged in the order of BGR in the unit of display of the odd number column. However, it is possible to have the same effect as above even if the display devices are arranged in order of RGB in the unit of display of the odd number column and in order of BGR in the unit of display of the even number column.

Further, in the present embodiment, one unit of display has the arrangement of RGB or the arrangement of BGR. However, it is possible to have the same effect as above even if the colors other than G center such as “GRB/BGR” or “GBR/RBG”.

Furthermore, in the present embodiment, the signal representing the two units of display of the original image is used as the original signal which is necessary to calculate the luminance information of the one unit of display. However, it is possible to use a signal representing much more units of display according to a scale of the low-pass filter circuit.

On another front, it is desirable for operational precision of the low-pass filter circuit of calculating, for example, the expression (5) based on the expressions (3) and (4) to be equal to or larger than quantization bits of the externally input image signal 15. For example, when the quantization bits of the image signal 15 are eight bits, it is desirable to perform the calculation by an operational circuit of eight bits or more.

In particular, in case of calculating the expression (5) based on the expressions (3) and (4), it is preferable for the operational precision of the low-pass filter circuit to be equal to or larger than ten bits to prevent affection of a round-off error.

Moreover, in case of installing the operational circuit, an ASIC (application specific integrated circuit) may be installed in terms of operation speed, consumption power, and a size of the circuit. Alternatively, an FPGA (Field Programmable Gate Array) may be used in terms of dynamic setting. When, the FPGA is used, a programming interface of the FPGA may be set in the display apparatus 1 so that the format of the expression (4) can externally be reset after shipment or the like.

Moreover, to enable a user to set the coefficient aᵢ in the expression (4) according to his/her preference in inspection before shipment or after shipment, each coefficient aᵢ may be saved in a PROM (programmable read only memory) or an RAM (random access memory) connected to the low-pass filter circuit.

Incidentally, although the low-pass filter circuit 14 is provided in the display apparatus 1 in the present embodiment, the present invention is not limited to this. Namely, when the display apparatus 1 is incorporated in an electronic device such as a digital camera, a mobile phone or the like, a circuit having an equivalent function may be provided on the side of the electronic device so that the signal by this circuit is input to the display apparatus 1.

This application claims the benefit of Japanese Patent Application No. 2010-088801, filed Apr. 7, 2010, which is hereby incorporated by reference herein in its entirety.

What is claimed is:

1. A display apparatus which comprises a display region on which a plurality of display devices are arranged in a matrix, wherein
the plurality of display devices include a first display device, a second display device and a third display device, and are arranged in order of the first display device, the second display device, the third display device, the third display device, the second display device and the first display device in a first direction,
luminescent colors of the first display device, the second display device and the third display device are different from others, and
the display apparatus comprises a low-pass filter circuit configured to modulate an image signal to be input to the display region.

2. The display apparatus according to claim 1, wherein
the first display device, the second display device and the third display device constitute one unit of display,
the low-pass filter circuit is electrically connected to each unit of display, and
an operation of the low-pass filter circuit for the display device on an even number column in the first direction is different from an operation of the low-pass filter circuit for the display device on an odd number column in the first direction.

3. The display apparatus according to claim 1, further comprising a difference filter circuit configured to modulate the image signal output from the low-pass filter circuit.

4. The display apparatus according to claim 1, wherein
the low-pass filter circuit comprises a circuit configured to perform a multiplication process of multiplying at least a specific signal by a coefficient, a delay element configured to adjust timing of the signal, and an adding unit configured to add the plurality of signals together, and
the coefficient is different according to a display column.
